(19) United States
(12) Patent Application Publication
(10) Pub. No.: US 2012/0158184 A1
(43) Pub. Date: Jun. 21, 2012

(54) METHOD FOR OPERATING MAKEUP ROBOT BASED ON EXPERT KNOWLEDGE AND SYSTEM THEREOF

(75) Inventors: Jin-Suk Ma, Daejeon (KR); Do Hyung Kim, Daejeon (KR); Sun Ja Kim, Daejeon (KR)

(73) Assignee: Electronics and Telecommunications Research Institute, Daejeon (KR)

(21) Appl. No.: 13/292,314

(22) Filed: Nov. 9, 2011

(30) Foreign Application Priority Data
Dec. 17, 2010 (KR) 10-2010-0130126

(51) Int. Cl. G06F 19/00

(52) U.S. Cl. 700/264; 700/245; 901/43; 901/47

(57) ABSTRACT

Disclosed is a makeup system based on expert knowledge including: a makeup robot controlled to apply a cosmetic to a face of a user; a makeup server expert system including makeup information associated with makeup application and command profile information created by programming operation commands of the makeup robot; and a makeup client system configured to download a command profile for controlling operation of the makeup robot from the makeup server expert system, and transmit the command profile to the makeup robot.

### CROSS-REFERENCE TO RELATED APPLICATIONS

This application is based on and claims priority from Korean Patent Application No. 10-2010-0130126, filed on Dec. 17, 2010, with the Korean Intellectual Property Office, the disclosure of which is incorporated herein in its entirety by reference.

### TECHNICAL FIELD

The present disclosure relates to a makeup robot based on expert knowledge, to which a principle of an inkjet printer is applied, and a system thereof More particularly, the present disclosure relates to an apparatus and system for effectively solving considerable mental and physical consumption necessary for makeup application by using a system based on knowledge of makeup experts and a makeup robot using a principle of an inkjet printer.

### BACKGROUND

Women put on makeup almost every day repetitively and simply by hand. Ordinary persons who are not experts complain of considerable inconvenience in selecting a touch suitable for their skin and face types, the season, the weather, and the latest trends. However, no technical methods for solving the inconvenience have been developed.

With the recent explosive increase in specialized jobs, makeup is an issue to men as well as women. The makeup application may be done using many various procedures and methods, depending on an individual's skin tone, skin color, skin condition, face area, the season, and the trends. For ordinary persons who are unskilled at applying makeup, proper application requires a lot of trial and error and repetition. Therefore, in order for ordinary persons to be skilled in makeup application, continuous effort and manual labor are required. However, this imposes a considerable burden in terms of cost and time. In particular, working women put on repetitive makeup almost every morning. If individual's mental stress necessary for such effort, spent time, and loss of money due to trial and error convert into monitory unit, it may reach a very considerable amount.

An ordinary person applies makeup in the order of a basic product, a sun cream, a makeup base, a foundation, concealer, and powder. Kinds and functions of cosmetics used in each step are so diverse that even experts have difficulty in keeping up with all of the products. Such complicated makeup methods are more serious problems for ordinary persons who have no professional knowledge about makeup. Ordinary persons who purchase cosmetics in practice generally know a suitable applying method, that is, an applying site, an applying surface, an applying thickness, a skin adaptation, and an aging, only after trial and error. Therefore, if a specific makeup method is provided in advance, a considerable social and economical ripple effect can be expected.

Due to continuous efforts of cosmetic companies, most cosmetic products that have existed in a powder or cream type are now supplied to users in a liquid type. Such a development is becoming a technical base that makes a detailed implementation approach of the present disclosure more tangible.

### SUMMARY

The present disclosure has been made in an effort to provide a technical solution for effectively solving considerable mental and physical consumption necessary for makeup application by using a system based on knowledge of makeup experts and a makeup robot using a principle of an inkjet printer.

An exemplary embodiment of the present disclosure provides a makeup system based on expert knowledge, including: a makeup robot controlled to apply a cosmetic to a face of a user; a makeup server expert system including makeup information associated with a makeup and command profile information created by programming operation commands of the makeup robot; and a makeup client system configured to download a command profile for controlling operation of the makeup robot from the makeup server expert system, and transmit the command profile to the makeup robot.

Another exemplary embodiment of the present disclosure provides a makeup method using a makeup robot, including: selecting a makeup style desired by a user from a makeup database; extracting a command profile corresponding to the selected makeup style; transmitting the command profile to a makeup client system; transmitting the command profile from the makeup client system to a makeup robot; and driving the makeup robot to perform a makeup operation to the user, based on the command profile.

According to the exemplary embodiments of the present disclosure, a spray type makeup method using a makeup robot based on expert knowledge effectively applies a cosmetic to the face of a user while volatile components are volatilized after the cosmetic is applied to the face of the user according to a predetermined procedure. Therefore, each step of the makeup is very repetitive and stable, and the makeup can be performed with high perfection.

The exemplary embodiments of the present disclosure can be programmed to constantly maintain time necessary for completion and makeup patterns, as compared to the work that is performed by a person's mood or manual labor. In the case of repetitive and everyday makeup of ordinary persons, a foundation makeup and a point makeup suitable for each person can be performed very effectively.

According to the exemplary embodiments of the present disclosure, the apparatus described in the present disclosure can be used for skin care, or demonstration of new products in beauty clinics, cosmetic shops, and so on.

According to the exemplary embodiments of the present disclosure, the user can easily put on makeup according to his or her own face type, the latest style, and his or her own taste, with the help of a makeup robot, based on data transmitted from a makeup server expert system, instead of the same makeup. Without regard to sex and age, everyone can select his or her optimal makeup and easily put on makeup with the help of the makeup robot.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram showing a configuration of a makeup robot system based on expert knowledge according to an exemplary embodiment of the present disclosure.

FIG. 2 is a conceptual diagram showing a configuration of a makeup robot used as a makeup apparatus according to an exemplary embodiment of the present disclosure.

FIG. 3 is a flowchart of a user's makeup robot driving method according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

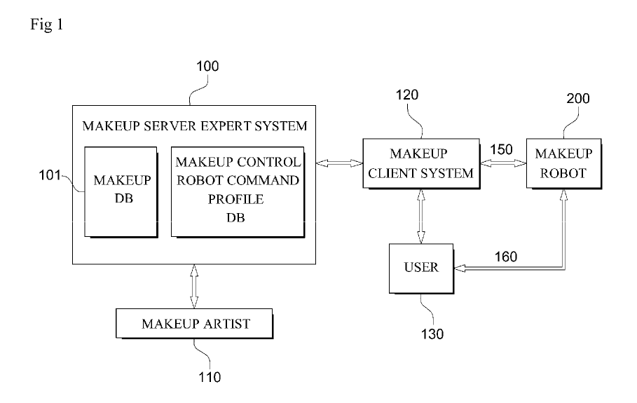

FIG. 1 is a block diagram showing a configuration of a makeup system using a makeup robot based on expert knowledge according to an exemplary embodiment of the present disclosure. The makeup system is roughly divided into a makeup server expert system 100, a makeup client system 120, and a makeup robot 200, and a makeup artist 110 manages makeup server expert system 100. A user 130 can access makeup client system 120, and makeup application can be performed by makeup robot 200.

Referring to FIG. 1, makeup server expert system 100 includes a makeup database (DB) 101 and a makeup control robot command profile DB 102.

Makeup DB 101 stores and manages a variety of information associated with the makeup by a makeup expert such as makeup artist 110 possessing professional makeup techniques. For example, makeup DB 101 may classify makeup information of the latest trends, season, situation, theme, skin type, age, and sex, which are input by makeup artist 110, according to categories, and store and manage the classified makeup information. The makeup information may be updated at every predetermined period and be continuously managed by makeup artist 110.

Makeup control robot command profile DB 102 includes a command profile programmed to construct each actual operation command of makeup robot 200, based on the information stored in makeup DB 101.

Makeup artist 110 can access makeup server expert system 100 through a wired/wireless communication network, including the Internet network. For example, makeup artist 110 can access makeup DB 101 through the Internet, and add and modify the makeup information. In order for makeup artist 110 to access makeup server expert system 100 in the above manner, administrator ID and password are required, and thus, access authorization can be restricted.

Makeup client system 120 includes a program necessary for user 130 to communicate with makeup server expert system 100 and makeup artist 110. User 130 can access makeup server expert system 100 through makeup client system 120. If necessary, user 130 can receive counseling by accessing makeup artist 110 through video chatting, voice chatting, or text chatting over the Internet network at a remote location. At this time, user 130 may receive an advice about his or her optimal makeup pattern through counseling with makeup artist 110.

After counseling with makeup artist 110 is completed, user 130 may download a command profile necessary for makeup robot 200 from makeup control robot command profile DB 102, based on the determined makeup pattern, and may transmit the command to makeup robot 200 such that makeup robot 200 executes a makeup operation by the command. At this time, makeup client system 120 operates as a setting system for controlling makeup robot 200.

Makeup client system 120 can be implemented using a dedicated hardware or may be implemented using a software program installed in a user terminal For example, makeup client system 120 may be easily implemented by downloading and installing a makeup client program using hardware such as an existing notebook, personal computer, or smart phone held by user 130.

If user 130 does not want to be counseled by makeup artist 110 or receive an advice from makeup artist 110, user 130 may simply connect to makeup server expert system 100, search makeup DB 101, and download makeup control robot command profile, which is desired in accordance to a user's demand and taste, from makeup control robot command profile DB 102. If the downloaded command profile is executed in makeup client system 120, makeup robot 200 is controlled according to the command and a makeup desired by user 130 can be done.

Makeup client system 120 and makeup robot 200 can communicate with each other over a wired/wireless communication network, and the operation of makeup robot 200 can be sophisticatedly controlled by the command of makeup client system 120. Makeup robot 200 may perform an operation 160 of applying an appropriate amount of cosmetic to a user's face for appropriate time under the control of makeup client system 120.

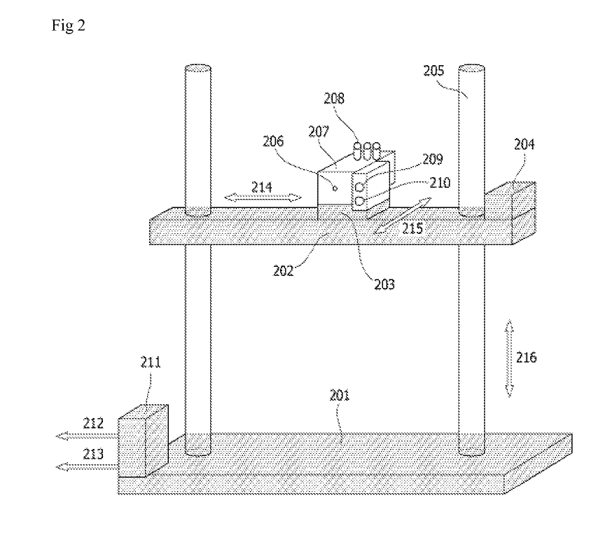

FIG. 2 is a conceptual diagram showing a configuration of a makeup robot according to an exemplary embodiment of the present disclosure. FIG. 2 shows a detailed mechanical configuration of makeup robot 200 depicted in FIG. 1.

Referring to FIG. 2, makeup robot 200 includes a support table 201, a horizontal rack 202, a gimbal 203, an elevating shaft driver 204, an elevating shaft support 205, a cosmetic nozzle 206, a head unit 207, a cosmetic cartridge 208, a video camera 209, a face distance measurer 210, a motor driver and command execution computer 211, a power connection part 212, and a communication unit 213.

Support table 201 is a mechanical support part of the cosmetic robot, and supports elevating shaft support 205 and motor driver and command execution computer 211. Horizontal rack 202 is a support table that supports the left-right movement 214 and front-rear movement 215 of gimbal 203. Horizontal rack 202 can be moved in an upward/downward direction 216 using a moving rail along elevating shaft support 205 by elevating shaft driver 204.

Gimbal 203 serves to receive and support head unit 207, video camera 209, and face distance measurer 210. Gimbal 203 is internally equipped with respective motors and position sensors that manage left-right movement 214 and front-rear movement 215, and serves to control the movement so that head unit 207, video camera 209, and face distance measurer 210 can work at an optimal face site of user 130. Elevating shaft driver 204 is a mechanism that manages upward/downward movement 216 of horizontal rack 202 and may include a motor part and a gear part. Elevating shaft driver 204 is embedded with a position sensor for detection of its own position. Thus, elevating shaft driver 204 can detect a relative position and height of horizontal rack 202 from support table 201 on elevating shaft support 205. Since each user 130 has a different facial contour, it is possible to provide position information necessary for optimally applying a cosmetic according to the facial contour of each user 130.

Head unit 207 serves to supply previously determined cosmetic components, which are supplied from cosmetic cartridge 208, to cosmetic nozzle 206. Head unit 207 serves to check a remaining amount of cosmetic in cosmetic cartridge 208 and determine whether replacement of cosmetic cartridge 208 is necessary.

Cosmetic nozzle 206 serves as spray cosmetic supplied from cosmetic cartridge 208 to the face of actual user 130. Video camera 209 serves to detect the face of current user 130 and monitor and detect an applying position and an applying color impression of the cosmetic. Video camera 209 can recognize each face part of user 130 by extracting feature points from video information of user 130.

Face distance measurer 210 functions to frequently check the distance between head unit 207 and the face of user 130 and calculate an optimal distance condition according to components of cosmetic to be applied. For example, face distance measurer 210 may be implemented using an ultrasonic sensor or an infrared sensor.

Cosmetic cartridge 208 may be configured as a liquid cosmetic product that is packaged in a cartridge type. Before driving makeup robot 200, user 130 may purchase a required amount or number of cosmetic cartridge 208 and mount cosmetic cartridge 208 on head unit 207 in predetermined order.

Motor driver and command execution computer 211 functions to receive the command transmitted from makeup client system 120 through communication unit 213. The command transmitted in this manner is interpreted for the respective driving shafts and is transmitted as a command to a motor driver driving motors for upward/downward movement 216, left-right movement 214, and front-rear movement 215. The motor driver serves to control the respective motors according to the command. Motor driver and command execution computer 211 may be implemented using a method that is widely used in an existing inkjet printer and so on.

Communication unit 213 operates as a communication interface that supports a wired/wireless communication predefined with makeup client system 120. Communication unit 213 may include a wired communication module, such as an existing USB, IEEE 1394, or RS232, and a wireless communication module, such as Bluetooth, WiFi, ZigBee, or wireless USB. In the case of using the wireless communication module, user 130 may conveniently use makeup robot 200 while moving makeup robot 200 without spatial limitation.

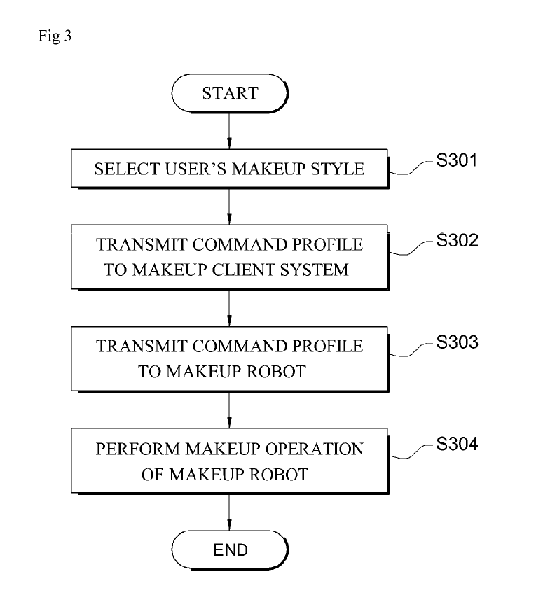

FIG. 3 is a flowchart of a user's makeup robot driving method according to an exemplary embodiment of the present disclosure.

User 130 may perform makeup application by driving makeup robot 200 through the following operations.

First, user 130 selects a makeup style suitable for his or her taste from makeup DB 101 of makeup server expert system 100 (S301).

Next, a command profile corresponding to the makeup style selected by user 130 is extracted and transmitted to makeup client system 120 (S302).

The command profile completely transmitted to makeup client system 120 is transmitted to motor driver and command execution computer 211 of makeup robot 200 in order for operation control of makeup robot 200 (S303).

Makeup robot 200 supplies cosmetic cartridge 208 to head unit 207 according to the command received from makeup client system 120, and performs the makeup application in a way of applying an appropriate amount of cosmetic to the face of user 130 for a predetermined time by using inkjet spray type cosmetic nozzle 206 (S304).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A makeup system based on expert knowledge, comprising:
a makeup robot controlled to apply a cosmetic to a face of a user;
a makeup server expert system including makeup information associated with makeup application and command profile information created by programming operation commands of the makeup robot; and
a makeup client system configured to download a command profile for controlling the operation of the makeup robot from the makeup server expert system, and transmit the command profile to the makeup robot.

2. The makeup system of claim 1, wherein the makeup server expert system comprises:
a makeup database configured to store and manage the makeup information by a makeup expert; and
a makeup robot command profile database configured to store and manage the command profile information based on the makeup information stored in the makeup database.

3. The makeup system of claim 2, wherein the makeup information is classified according to at least one of the latest trends, season, situation, theme, skin type, age, and sex.

4. The makeup system of claim 2, wherein the makeup expert is accessible to the makeup database through the Internet.

5. The makeup system of claim 1, wherein the makeup client system is implemented by installing a makeup client program in the user's personal terminal

6. The makeup system of claim 2, wherein the makeup client system provides a remote counseling between the user and the makeup expert.

7. The makeup system of claim 2, wherein the user accesses the makeup server expert system, searches the makeup database, and downloads a command profile linked to a desired makeup pattern from the makeup robot command profile database.

8. The makeup system of claim 1, wherein the makeup robot comprises a communication unit configured to communicate with the makeup client system.

9. The makeup system of claim 8, wherein the communication unit comprises at least one of Bluetooth, WiFi, ZigBee, and wireless USB communication modules.

10. The makeup system of claim 8, wherein the makeup robot further comprises a command execution computer configured to interpret the command profile received through the communication unit and control a motor driver for driving a motor.

11. The makeup system of claim 10, wherein the makeup robot further comprises:
a cosmetic nozzle configured to spray a cosmetic to the face of the user; and
a head unit configured to supply the cosmetic to the cosmetic nozzle.

12. The makeup system of claim 11, wherein the makeup robot further comprises a video camera configured to detect the face of the user and monitor and detect an applying position and an applying color impression of the cosmetic.

13. The makeup system of claim 11, wherein the makeup robot further comprises a face distance measurer configured to detect a distance between the head unit and the face of the user and calculate an optimal distance condition according to components of a cosmetic to be applied.

14. The makeup system of claim 13, wherein the face distance measurer comprises an ultrasonic sensor or an infrared sensor.

15. A makeup method using a makeup robot, comprising:
selecting a makeup style desired by a user from a makeup database;
extracting a command profile corresponding to the selected makeup style;
transmitting the command profile to a makeup client system;
transmitting the command profile from the makeup client system to a makeup robot; and
driving the makeup robot to perform a makeup operation to the user, based on the command profile.
